(19) United States
(12) Patent Application Publication
(10) Pub. No.: US 2021/0031549 A1
(43) Pub. Date: Feb. 4, 2021

(54) MARKING APPARATUS

(71) Applicant: Target Household Repair and Services Inc., Brampton (CA)

(72) Inventors: Douglas B. Cross, Brampton, Ontario (CA); Jeff Dayman, Waterloo, Ontario (CA); Tony Stewart, Toronto, Ontario (CA)

(73) Assignee: Target Household Repair and Services Inc., Brampton, ON (CA)

(21) Appl. No.: 16/966,668

(22) PCT Filed: Feb. 1, 2019
(86) PCT No.: PCT/CA2019/050132

§ 371 Date: Jul. 31, 2020

Related U.S. Application Data
(60) Provisional application No. 62/625,088, filed on Feb. 1, 2018.

(51) Int. Cl. B41K 1/40; B41K 1/22; B41K 1/56

(52) U.S. Cl. CPC B41K 1/40; E01C 23/163; B41K 1/56; B41K 1/22

(57) ABSTRACT

A wheel part includes: a body having an axis; an annular outer surface through which the axis extends centrally and defining a socket; a stamp mounted in the socket for movement between an extended position wherein the stamp projects radially beyond the surface and a retracted position wherein the stamp terminates radially inwardly beneath the surface; and a bias mechanism adapted to bias the stamp for movement to the extended position. A manually grippable handpiece is adapted to releasably receive the body for rotatable movement about the axis and is adapted such that at least a portion of the surface projects beyond the housing. An inker is mounted to the handpiece in spaced relation to the surface such that, on rotation of the wheel, the stamp engages the inker and receives ink therefrom, whereby, when the body is roiled along a workpiece, the workpiece is demarcated at uniform intervals.

### FIELD

The invention relates to the field of construction.

### BACKGROUND OF THE INVENTION

In the field of construction, it is often desirable to place marks at uniform intervals, for example, for spacing studs along a sill plate, or securing sheathing to framing.

### SUMMARY OF THE INVENTION

Forming one aspect of the invention is apparatus comprising a wheel part, a handpiece and an inker.

The wheel part includes a body, a stamp and a biaser. The body has an axis and an annular outer surface through which the axis extends centrally and defining a socket. The stamp is mounted in the socket for movement between an extended position wherein the stamp projects radially beyond the annular surface and a retracted position wherein the stamp terminates radially inwardly beneath the outer surface. The biaser is adapted to bias the stamp for movement to the extended position.

The handpiece is manually grippable, adapted to releasably receive the body for rotatable movement about the axis and adapted such that at least a portion of the annular surface projects beyond the housing when the body is so releasably received.

The inker is mounted to the handpiece in spaced relation to the annular surface such that, on rotation of the wheel, the stamp engages the inker and receives ink therefrom such that, when the body is rolled along a surface, the surface is demarcated at uniform intervals by the stamp.

According to another aspect of the invention, the inker can be a roller mounted in a cartridge, the cartridge being releasably mounted to the handpiece.

According to another aspect of the invention, the handpiece can have a threaded socket of the type provided on a paint roller frame and be orientated such that, when the handpiece is mounted by the socket on a threaded shaft, marks can be placed at regular intervals: (i) upon an overhead surface by handling the apparatus in the manner in which a paint roller is used to paint a ceiling and marks; and (ii) upon a floor surface by handling the apparatus in the manner in which a field marker is used to line a field.

According to another aspect: (i) the body can have a pair of protruding pintles defining the axis; and (ii) the handpiece can include: a housing which defines, for each pintle, a slot, the slot receiving the pintle for which it is defined when the body is releasably received by the handpiece; and a locking member which is adapted for releasable engagement with the housing, the locking member and which, when the pintles of the body are received by the slots and when the locking member is releasably engaged with the housing, retains the pintles in the slots.

Forming another aspect of the invention is a system comprising a pair of wheel parts, a handpiece and an inker.

The pair of wheel parts each include a body, a stamp and a biaser. The body has an axis and an annular outer surface through which the axis extends centrally and defining a socket, the annular surface of one of the pair of wheel parts being of larger diameter than the annular surface of the other of the pair of wheel parts. The stamp is mounted in the socket for movement between: an extended position wherein the stamp projects radially beyond the annular surface; and a retracted position wherein the stamp terminates radially inwardly beneath the annular surface. The biaser is adapted to bias the stamp for movement to the extended position.

The handpiece is: (i) manually grippable; (ii) adapted to releasably receive the bodies, one at a time, for rotatable movement about the axis and (iii) adapted such that at least a portion of the annular surface of the body received by the handpiece projects beyond the handpiece.

The inker, in use, is mounted to the handpiece in spaced relation to the annular surface of the body received by the handpiece such that, on rotation of such body, the stamp engages the inker and receives ink therefrom, such that, when either of the bodies is rolled along a surface, the surface is demarcated at uniform intervals by the stamp, the uniform intervals associated with the one of the pair of wheels being different than the uniform intervals associated with the other of the pair of wheels.

According to another aspect: (i) each body can have a pair of protruding pintles defining the axis; and (ii) the handpiece can include: a housing which defines, for each pintle, a slot, the slot receiving the pintle for which it is defined when the body is releasably received by the handpiece; and a locking member which is adapted for releasable engagement with the housing, the locking member and which, when the pintles of the body are received by the slots and when the locking member is releasably engaged with the housing, retains the pintles in the slots.

Advantages, features and characteristics of the invention will become apparently upon a review of the detailed description which follows, with reference to the appended drawings, the latter being briefly described hereinbelow.

### BRIEF DESCRIPTION OF THE DRAWINGS

FIG. 1 is a view of the components of a system that forms an exemplary embodiment of the invention

FIG. 2 is a view of the structure of encircled area 2 of FIG. 1 assembled for use with the structure of encircled area 3 of FIG. 1

FIG. 3 is an enlarged view, from a different vantage point, of the structure of encircled area 3 of FIG. 1;

FIG. 4 is a view of the structures of encircled areas 2, 3, 4A and 9 of FIG. 1, positioned for assembly;

FIG. 5 is a view of the structures of FIG. 4 assembled for use;

FIG. 6 is a view of the structure of FIG. 5, with the guide moved to the extended position;

FIG. 7 is a view of the structure of FIG. 6 in use;

FIG. 8 is a view of the structure of FIG. 5 in use with a threaded shaft;

FIG. 9 is a view of the structures of encircled areas 2, 3, 4B and 9 of FIG. 1, positioned for assembly;

FIG. 10 is a view of the structures of FIG. 9 assembled for use;

FIG. 11 is an end view of the structure of FIG. 5;

FIG. 12 is a view along section 12-12 of FIG. 11;

FIG. 13 is an enlarged view of encircled area 13 of FIG. 12;

FIG. 14 is a front, left, top perspective view of an alternate embodiment;

FIG. 15 is a bottom, rear, left perspective view of the structure of FIG. 14;

FIG. 16 is a front, left, bottom perspective view of the structure of FIG. 14; and

FIG. 17 is a top, left, rear perspective view of the structure of FIG. 14.

### DETAILED DESCRIPTION

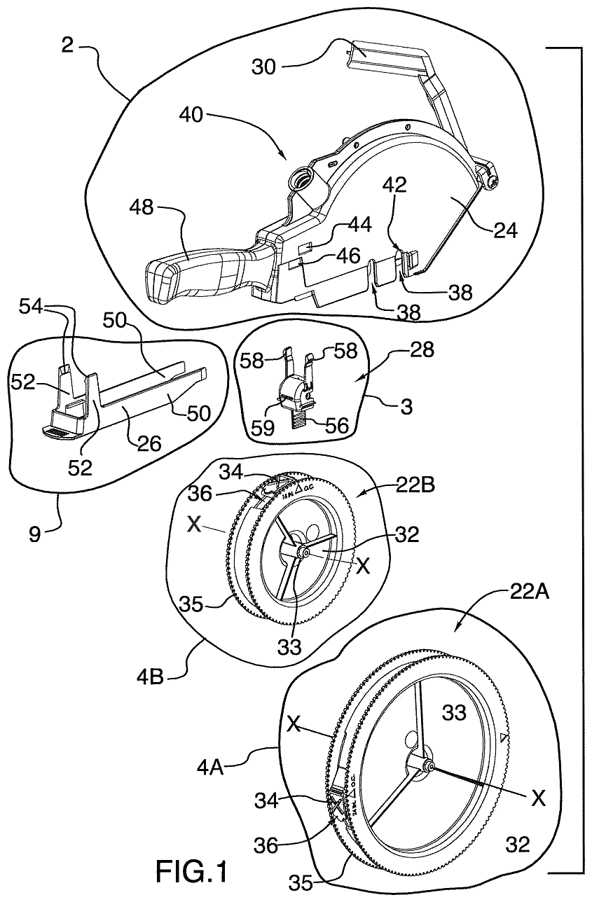

FIG. 1 shows a system 20 according to an exemplary embodiment of the invention. The system will be seen to comprise a pair of wheel parts 22A,22B, a housing 24, a locking member 26, a cartridge 28 and a guide 30.

The wheel parts 22A,22B each include a body 32, a stamp 34 and a biaser 36.

Each body 32 has (i) a pair of pintles 33 defining an axis X-X and (ii) a toothed annular outer surface 35 through which the axis X-X extends centrally and defining a socket; the annular surface 35 of one 22A of the pair of wheel parts will be seen to be larger in diameter than the annular surface of the other 226 of the pair of wheel parts but otherwise the wheel parts are similar.

The stamp 34 is mounted in the socket for movement between: an extended position wherein the stamp projects radially beyond the annular surface; and a retracted position wherein the stamp terminates radially inwardly beneath the annular surface.

The biaser 36 is a spring adapted to bias the stamp for movement to the extended position.

The housing 24 defines a plurality of slots 38, a threaded socket 40, a pair of cavities 42, a pair of recesses 44 and a pair of voids 46 and is manually grippable by means of a handle 48. The threaded socket 40 will be understood to be of the type generally provided on a paint roller frame.

The locking member 26 has a pair of protruding legs 50 and a pair of gripping arms 52, each arm 52 terminating in a detent 54.

The cartridge 28 has a ribbed tab 56, a pair of protruding fingers 58 and an inker 60 in the form of a rotatably mounted gel cylinder loaded with ink. The cartridge will further be seen to have a protruding rib 59.

The guide 30 is pivotably mounted to the housing 24 and is shown in FIG. 1 in a retracted position.

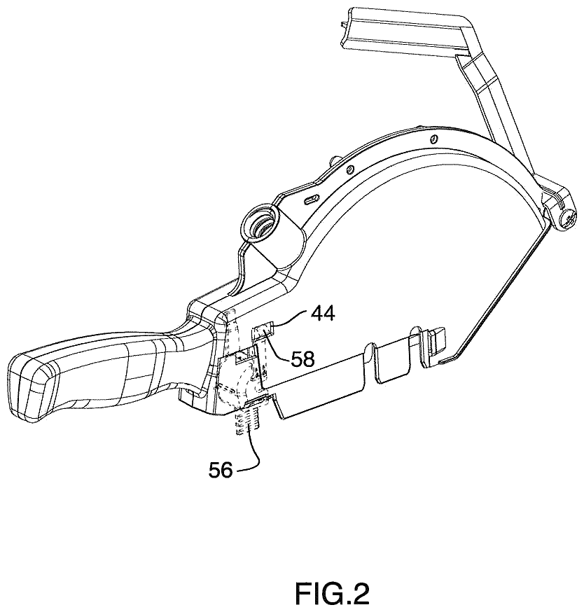

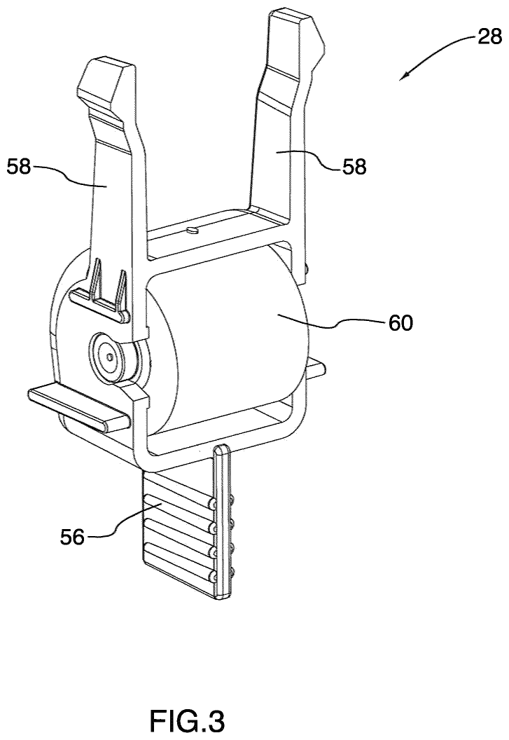

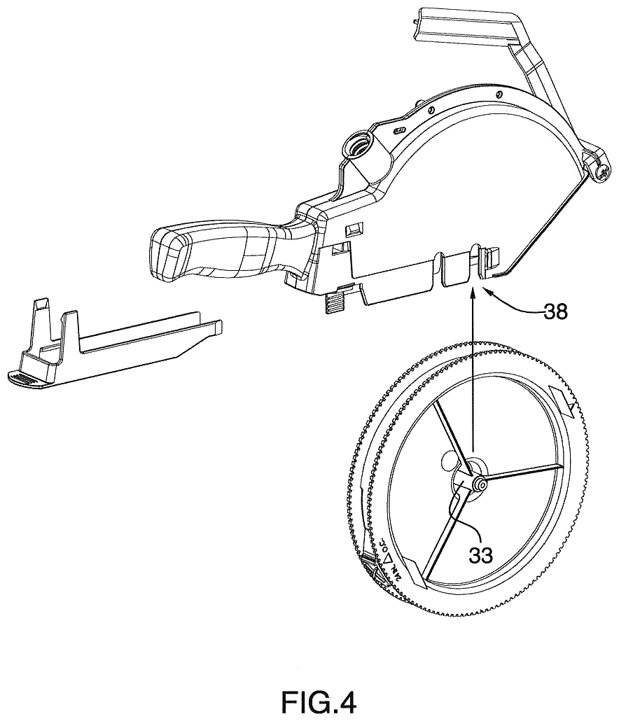

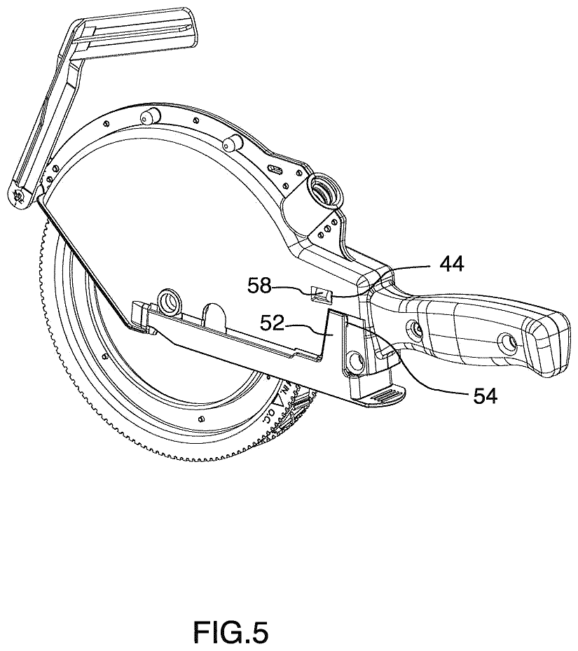

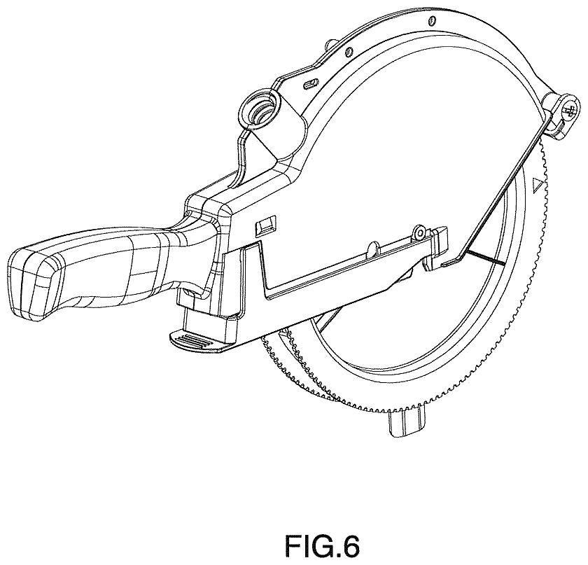

In use:
the fingers 58 of the cartridge are engaged in the recesses 44 of the housing, thereby to releasably mount the cartridge to the housing, all as indicated by FIG. 2
the pintles 33 of one of the wheel parts are fitted in a pair of the slots 38 such that at least a portion of the annular surface of the body received by the housing projects beyond the housing, the legs 50 of the locking member are received by the cavities 42 of the housing and the detents 54 of the locking member are received by the voids 46, thereby locking the wheel in place, all as shown by the sequence of FIGS. 4, 5

So assembled, when the body is rolled along a surface:
the stamp engages the inker and receives ink therefrom; and
the surface is demarcated at uniform intervals by the stamp, the uniform intervals varying depending upon the wheel part in use.

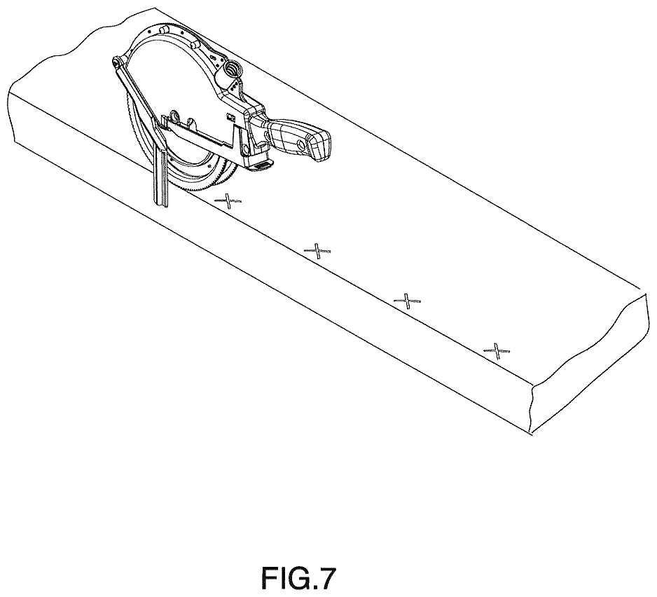

Movement of the guide member to an extended position allows the apparatus to be rolled along the edge of a surface as indicated by FIG. 7. This is useful, for example, for marking sill plates and rim plates.

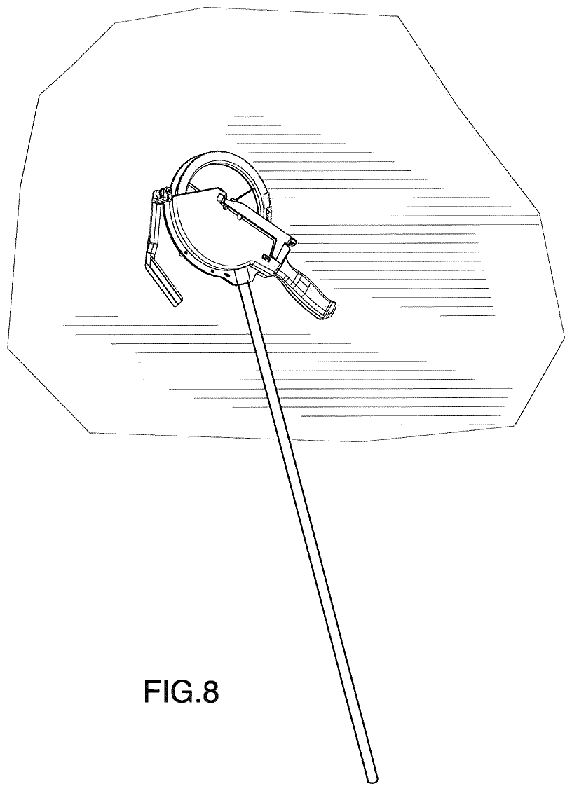

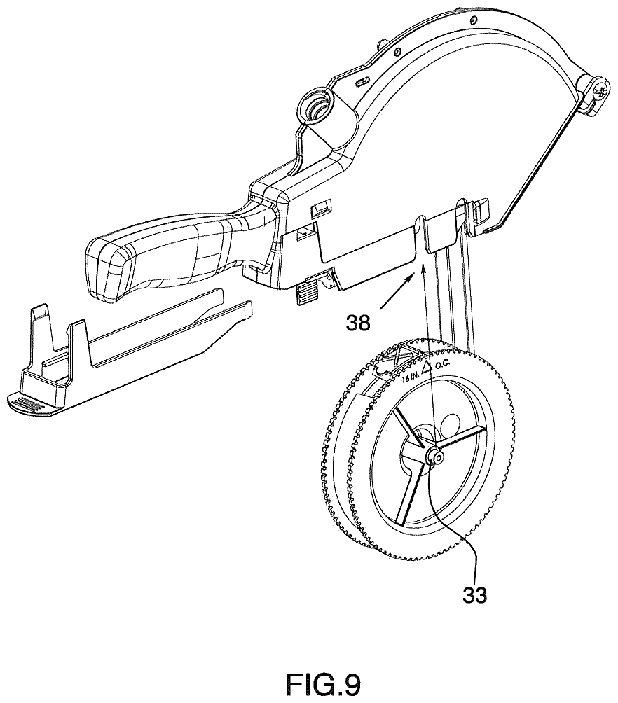

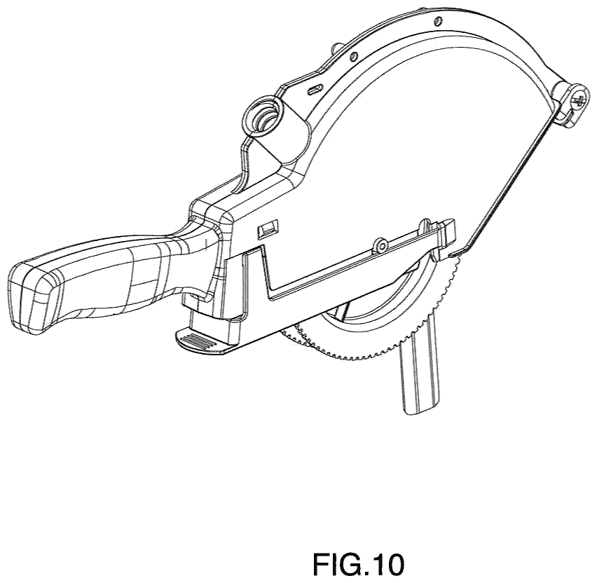

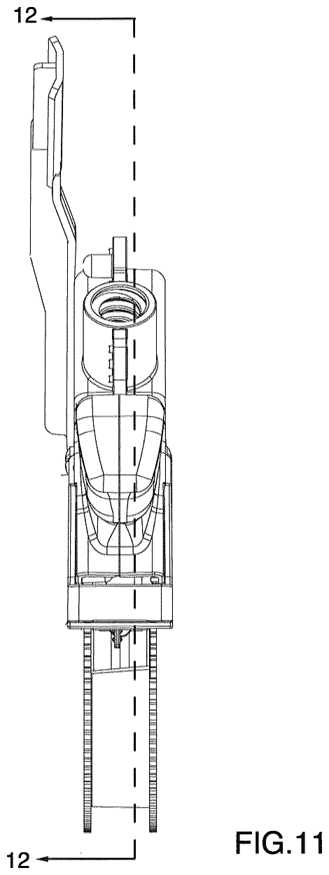

By fitting a threaded shaft into the threaded socket, marks can be placed at regular intervals:
upon an overhead surface by handling the apparatus in the manner in which a paint roller is used to paint a ceiling and marks, as indicated by FIG. 8; and
upon a floor surface by handling the apparatus in the manner in which a field marker is used to line a field.

It will be appreciated that the slots 38 are positioned such that, when 22B is used, the pintles 33 are disposed in the other of the slots such that the stamp and inker and brought into operative position notwithstanding the smaller diameter.

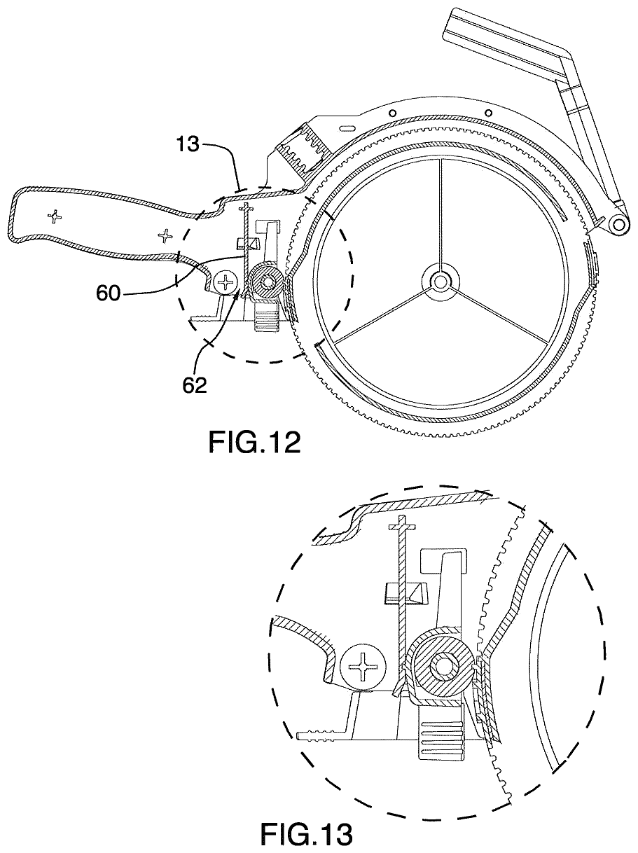

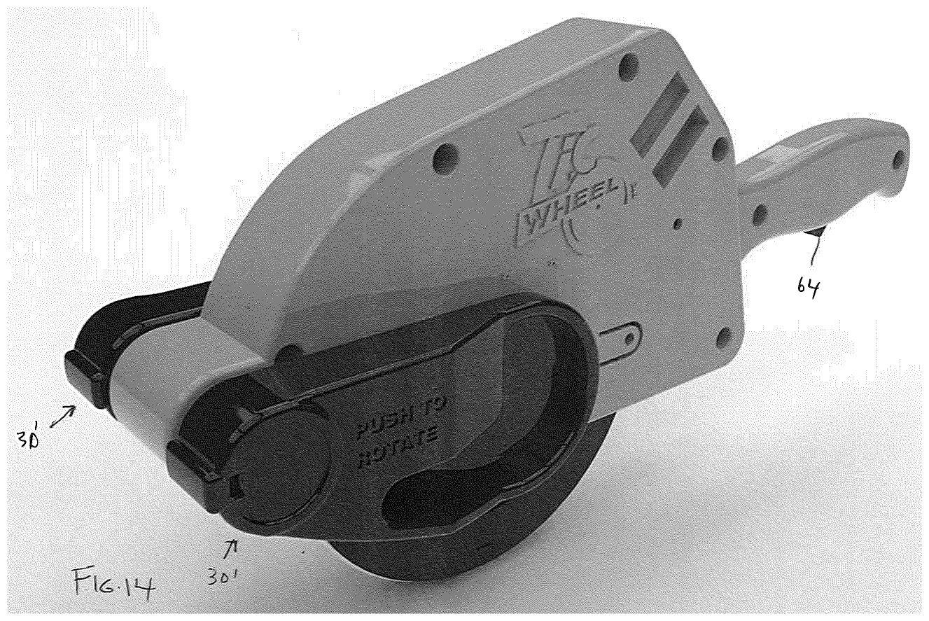

FIGS. 12 and 13 disclose further details of the manner in which the cartridge is engaged in the housing, more particularly, housing 24 will be seen to include a resilient tang 60 having a groove 62 defined therein. As the cartridge is inserted into the housing, the tang is urged towards the handle until such time as the rib 59 of the cartridge reaches the groove in the tang 60 and detents 54 reach recesses 44, whereupon the tang returns to the original position and locks the cartridge in place.

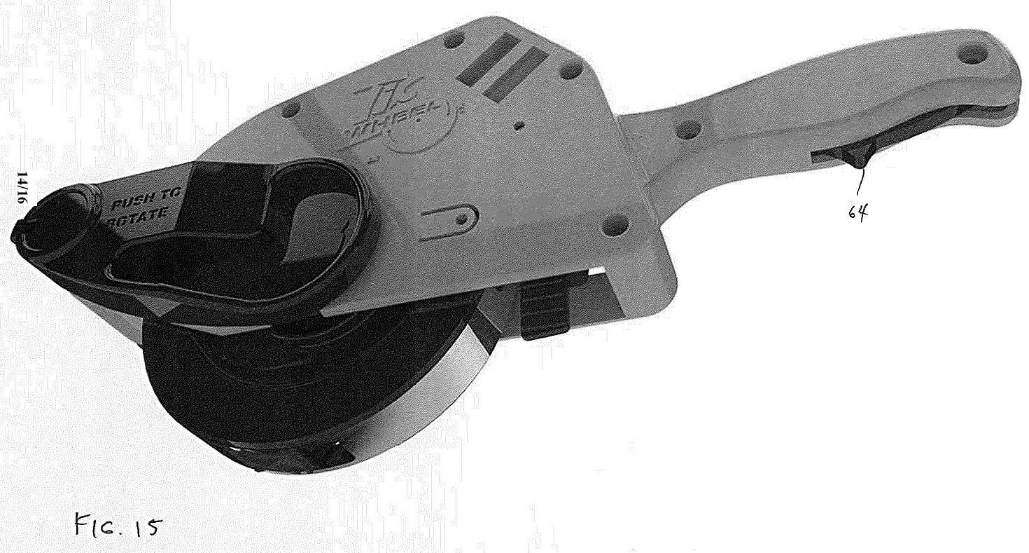

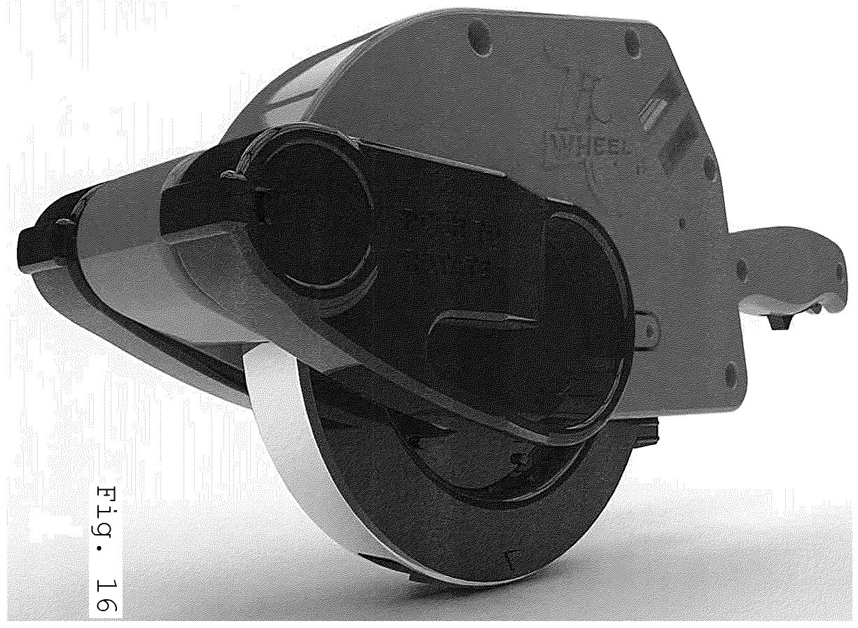

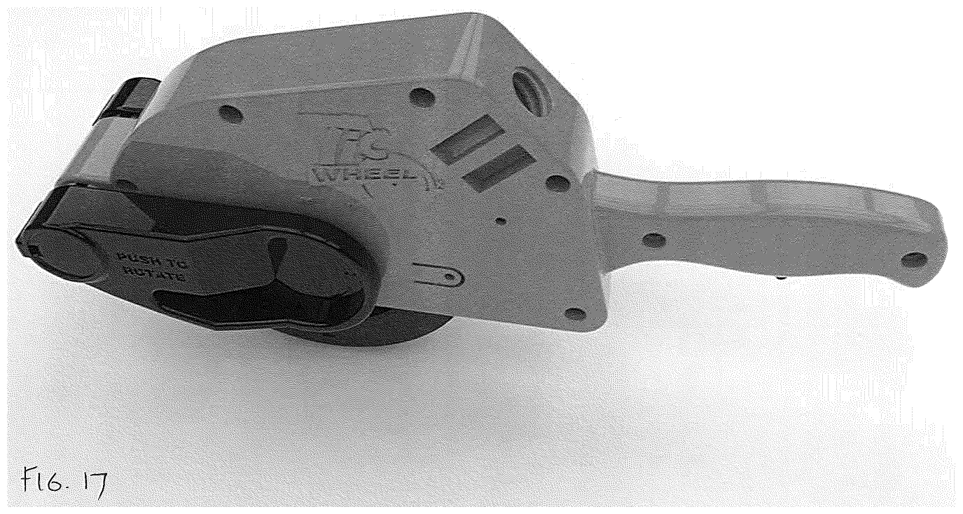

An alternative embodiment of the invention is shown in FIG. 14 through FIG. 17. This embodiment functions similarly and thus is not shown in detail. Notable differences include:
the overall aesthetic;
a hook pivotally mounted to the handle for movement between an extended position (not shown), whereat the hook extends to permit the apparatus to be suspended therefrom, and a nested position, shown, whereat the hook is disposed within the handle, protruding only slightly to permit manual withdrawal;
modified guides 30′ disposed on both sides of the apparatus which provide functionality similar to that of previously described guide 30 but are shaped differently and pivot only when urged towards the apparatus, to avoid inadvertent dislodgement during use; and
a laser marker, not shown, mounted interiorly of the stamp and directed radially outwardly, thereby to permit a user to easily align the marker with a desired starting point on a workpiece.

Whereas two specific embodiments are illustrated and described, variations will be understood to be possible. Without limitation in this regard, it will be understood that wheels of different diameters can be provided, to provide for variable spacing, and marking cylinders of different construction can be provided, to allow for use on varying surfaces and for varying purposes. Accordingly, the invention should be understood to be limited only by the accompanying claims, purposively construed.

1. Apparatus comprising:
a wheel part including:
a body having
an axis,
an annular outer surface through which the axis extends centrally and defining a socket,
a stamp mounted in the socket for movement between
an extended position wherein the stamp projects radially beyond the annular surface and a retracted position wherein the stamp terminates radially inwardly beneath the outer surface
a bias mechanism adapted to bias the stamp for movement to the extended position
a manually grippable handpiece adapted to releasably receive the body for rotatable movement about the axis and adapted such that at least a portion of the annular surface projects beyond the housing; and
an inker mounted to the handpiece in spaced relation to the annular surface such that, on rotation of the wheel, the stamp engages the inker and receives ink therefrom,
whereby, when the body is rolled along a surface, the surface is demarcated at uniform intervals by the stamp.

2. Apparatus according to claim 1, wherein the inker is a roller mounted in a cartridge, the cartridge being releasably mounted to the handpiece.

3. Apparatus according to claim 1, wherein the handpiece has a threaded socket of the type provided on a paint roller frame and orientated such that, when the handpiece is mounted by the socket on a threaded shaft, marks can be placed at regular intervals
upon an overhead surface by handling the apparatus in the manner in which a paint roller is used to paint a ceiling and marks
upon a floor surface by handling the apparatus in the manner in which a field marker is used to line a field.

4. Apparatus according to claim 1, wherein
the body has a pair of protruding pintles defining the axis; and
the handpiece includes
a housing which defines, for each pintle, a slot, the slot receiving the pintle for which it is defined when the body is releasably received by the handpiece;
a locking member which is adapted for releasable engagement with the housing, the locking member and which, when the pintles of the body are received by the slots and when the locking member is releasably engaged with the housing, retains the pintles in the slots.

5. Apparatus comprising:
a pair of wheel parts, each including:
a body having: an axis; and an annular outer surface through which the axis extends centrally and defining a socket;
a stamp mounted in the socket for movement between: an extended position wherein the stamp projects radially beyond the annular surface; and a retracted position wherein the stamp terminates radially inwardly beneath the annular surface; and
a bias mechanism adapted to bias the stamp for movement to the extended position
the annular surface of one of the pair of wheel parts being of larger diameter than the annular surface of the other of the pair of wheel parts;
a manually grippable handpiece adapted to releasably receive the bodies, one at a time, for rotatable movement about the axis and adapted such that at least a portion of the annular surface of the body received by the handpiece projects beyond the handpiece; and
an inker mounted to the handpiece in spaced relation to the annular surface of the body received by the handpiece such that, on rotation of such body, the stamp engages the inker and receives ink therefrom,
whereby, when either of the bodies is rolled along a surface, the surface is demarcated at uniform intervals by the stamp, the uniform intervals associated with the one of the pair of wheels being different than the uniform intervals associated with the other of the pair of wheels.

6. Apparatus according to claim 1, wherein:
each body has a pair of protruding pintles defining the axis; and
the handpiece includes:
a housing which defines, for each pintle, a slot, the slot receiving the pintle for which it is defined when the body is releasabiy received by the handpiece; and
a locking member which is adapted for releasable engagement with the housing, the locking member and which, when the pintles of the body are received by the slots and when the locking member is releasably engaged with the housing, retains the pintles in the slots.
